(19) United States
(12) Patent Application Publication
(10) Pub. No.: US 2023/0182884 A1
(43) Pub. Date: Jun. 15, 2023

(54) PORTABLE BALLOON LAUNCH SYSTEMS

(71) Applicant: Pioneer Astronautics, Lakewood, CO (US)

(72) Inventor: Robert Zubrin, Lakewood, CO (US)

(21) Appl. No.: 18/063,941

(22) Filed: Dec. 9, 2022

Related U.S. Application Data
(60) Provisional application No. 63/288,097, filed on Dec. 10, 2021.

(51) Int. Cl. B64B 1/40

(52) U.S. Cl. CPC B64B 1/40; B64B 1/48

(57) ABSTRACT

Systems and methods herein provide for balloon launching. In one embodiment, a Portable Balloon Launch System (PBLS) includes a tank operable to retain water, and a reactor fluidly coupled to the tank and comprising a reductant material that reacts with the water to produce a lift gas. The PBLS also includes a first valve operable to release the water into the reactor, and an exhaust operable to vent the lift gas into a balloon to inflate the balloon. The lift gas is lighter than air so as to lift the balloon into the atmosphere.

### CROSS REFERENCE TO RELATED APPLICATIONS

This patent application claims priority to, and thus the benefit of an earlier filing date from, U.S. Provisional Patent Application No. 63/288,097 (filed Dec. 10, 2021), the contents of which are hereby incorporated by reference.

### BACKGROUND

Balloons have an extensive military history. For example, at the Battle of Fleurus in 1794, the French employed the balloon L'Entreprenant to provide battlefield reconnaissance, achieving a victory of historic importance, as it resulted in the defeat of the First Coalition and the overthrow of Robespierre. Following this success, balloon battlefield reconnaissance became an accepted auxiliary to the French revolutionary and Napoleonic armies and was employed by Union forces in the American Civil War as well. In World War I, the Germans employed zeppelins extensively for both reconnaissance and strike missions. As heavier than air aircraft developed, the use of balloons for strike missions became obsolete. However, air operations greatly increased the importance of predicting weather and determining winds, roles for which balloons were and still remain uniquely suitable.

Moreover, a balloon's ability to remain aloft for extended periods of time continued to make them of great use for reconnaissance and communication relays. In World War II, the U.S. Navy employed over 130 K-class blimps for anti-submarine surveillance service in both the Atlantic and Pacific theaters. These balloons detected numerous submarines, adding greatly to convoy safety—so much so that they were employed to protect the ship taking Franklin Roosevelt and Winston Churchill to the 1945 Yalta conference. Balloons were used for reconnaissance over the Soviet Union in the 1950s, as airborne radar platforms by U.S. armed forces in Desert Storm, and are even used by the border patrol today.

While many of the traditional reconnaissance and communication link functions of balloons can be fulfilled today by satellites, balloons continue to offer advantages, as they can be launched much more cheaply and quickly than satellites, allowing them to meet an immediate need with dispatch. Furthermore, satellites are relatively few in number and their orbits are predictable, allowing adversaries to hide their movements to avoid observation, or, in some instances, to take the satellites out. For these reasons, organizations have stated a need for numerous assets that are rapidly deployable and relatively inexpensive to complement orbital capabilities.

The traditional method of launching balloons used compressed lighter than air gases, such as hydrogen or helium. This method is operable, but the method has some drawbacks. For example, compressed hydrogen presents a hazard, while helium is an expensive and finite resource. Moreover, compressed gas bottles that are required are heavy. It generally requires an entire 60 kg K-bottle of helium to provide sufficient lift to launch a 5 kg payload. This creates a logistics problem for military applications, as such bottles are typically transported to theater from the continental United States, making it difficult to support a balloon launch program abroad even from established bases and by small teams operating in remote locations. And large/heavy bottles to launch balloons on demand are difficult to deploy in many military operations. But air launch of balloons is needed to provide responsive capability to distant locations with balloons carrying communications and/or reconnaissance high altitude payloads.

### SUMMARY

Systems and methods herein provide for balloon inflation. Generally, the systems and methods presented herein overcome the prior systems and methods by reducing the overall mass using chemical reactions to produce lighter than air gases from storable liquids. The Portable Balloon Launch Systems (PBLS) could be used to rapidly deploy high altitude reconnaissance and/or communications platforms wherever needed.

Variants of the PBLS can be used in airborne launches, shipboard launches, reentry capsules released from orbital assets, ground launches, submarine launches, and the like.

In one embodiment, the PBLS consists of a reactor immersed in a tub of water, with a water feed vessel, connected to it by a pipe, positioned above it. When a valve is opened, water from the feed tank enters the reactor and reacts with a highly reducing chemical to produce hydrogen gas, steam, and a sold residue that remains in solution. Steam produced by the reaction is condensed by the reactor walls and is cooled by the surrounding tub of water. The condensed steam then falls down the reactor walls to react with the powder. Hydrogen gas produced from the reactor is then piped to another condenser vessel which is immersed in cold water which removes any remaining steam from the hydrogen. The dry hydrogen is then piped to a balloon to support inflation and launch.

In another embodiment, a PBLS includes a deployment parachute, a balloon, a payload gondola, and an inflation system. When the time comes to initiate operations, the PBLS may be dropped from an aircraft. The parachute then deploys, and the balloon is inflated during descent, for example, using hydrogen generated by reacting water with a relatively small amount of a highly reducing chemical contained in the inflation system. Once inflation is complete, the balloon is disconnected from the parachute and the inflation system drops away from the balloon. Afterwards, the balloon and gondola float to high altitude to perform its mission.

In still another embodiment, the reactor and condenser are immersed in sea water, which is used to cool both of them, thereby facilitating balloon launch from ships or submarines with minimal hardware requirements.

In another embodiment, a balloon launch system includes a tank operable to retain water, and a reactor fluidly coupled to the tank. The reactor includes a reductant material that reacts with the water to produce a lift gas. The system also includes a first valve operable to release the water into the reactor, and an exhaust operable to vent the lift gas into a balloon to inflate the balloon, the lift gas being lighter than air to lift the balloon into an atmosphere.

In another embodiment, a method of launching a balloon includes fluidly coupling a reactor to a source of water. The reactor holds a material that reacts with the water. The method also includes opening a first valve to release the water into the reactor to produce a lift gas based on a reaction between the water and the reductant material, and exhausting the lift gas from the reactor into the balloon to inflate the balloon, the lift gas being lighter than air to lift the balloon into an atmosphere.

The various embodiments disclosed herein may be implemented in a variety of ways as a matter of design choice. For example, some embodiments herein are implemented in hardware, whereas other embodiments may include processes that are operable to implement and/or operate the hardware. Other exemplary embodiments, including hardware, software, firmware, and various combinations thereof are described below.

### BRIEF DESCRIPTION OF THE FIGURES

Some embodiments are now described, by way of example only, and with reference to the accompanying drawings. The same reference number represents the same element or the same type of element on all drawings.

FIG. 1 is a block diagram of an exemplary balloon inflation system configured with a gondola of a balloon.

FIG. 2 is a more detailed block diagram of the exemplary balloon inflation system.

FIGS. 3A-3D exemplarily illustrate a deployment of the balloon inflation system with a parachute.

FIG. 4 is a graph exemplarily illustrating altitude versus payload mass of a balloon inflated with the balloon inflation system.

FIGS. 5A and 5B illustrate various exemplary methods of deploying a balloon with the balloon inflation system.

FIG. 6 is a graph exemplarily illustrating that a LiH reaction with water.

FIG. 7 is a flow chart of an exemplary process for generating a lift gas to inflate a balloon.

FIG. 8 is a block diagram of an exemplary computing system in which a computer readable medium provides instructions for performing one or more methods herein.

FIG. 9 illustrates a perspective view of an exemplary 10 kg of lift gas PBLS embodiment.

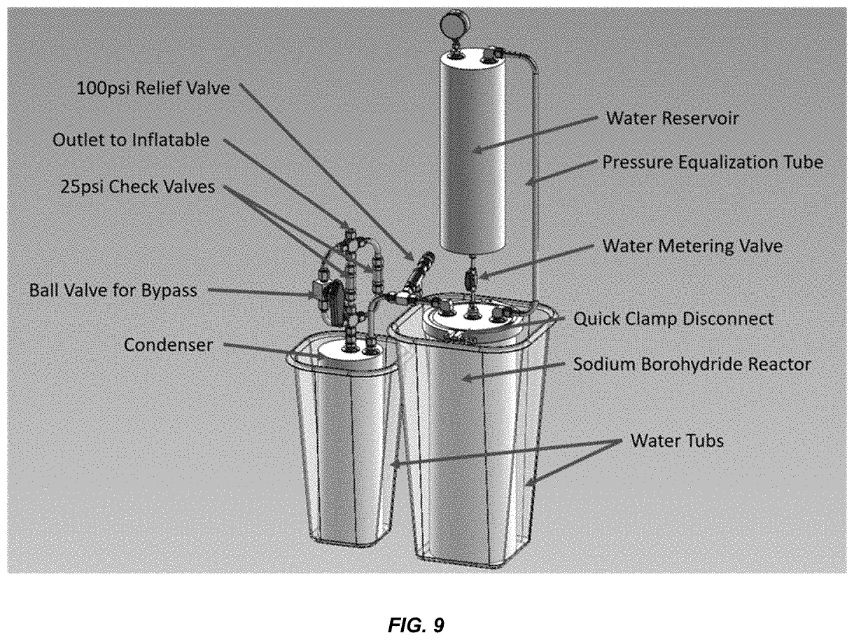

FIG. 10 illustrates a perspective view of another exemplary PBLS embodiment with pressurized water being fed into the reactor.

FIG. 11 illustrates flight path of a test of an exemplary PBLS.

FIG. 12 shows the complete flight of the PBLS test of FIG. 11.

### DETAILED DESCRIPTION OF THE FIGURES

The figures and the following description illustrate various exemplary embodiments. It will thus be appreciated that those skilled in the art will be able to devise various arrangements that, although not explicitly described or shown herein, embody various principles of design and/or operation and are included within the scope of the embodiments. Furthermore, any examples described herein are intended to aid in understanding the principles of the embodiments and are to be construed as being without limitation to such specifically recited examples and conditions.

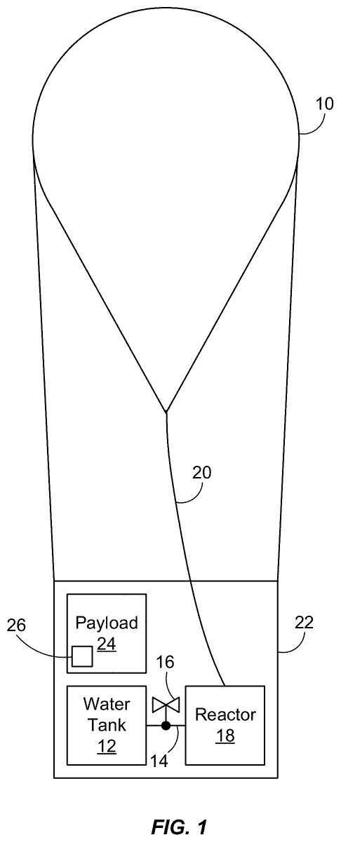

FIG. 1 is a block diagram of an exemplary balloon inflation system configured with a gondola 22 of a balloon 10. In this embodiment, the balloon inflation system is configured from a water tank 12, a reactor 18, a fluid coupling 14 between the water tank 12 and the reactor 18, a valve 16 on the fluid coupling, and an exhaust 20 to the balloon 10. When the balloon 10 is to be inflated, the valve 16 is controllably opened such that water from the water tank 12 may flow into the reactor 18. Once the water begins flowing into the reactor 18, the water begins reacting with material contained within the reactor 18 to disassociate the material into, among other things, a lift gas that is lighter than air, such as hydrogen. The reactor 18 then exhausts the lift gas into the balloon via the exhaust 20 to inflate the balloon 10 and to ascend the balloon 10 into the atmosphere with its payload 24 (e.g., radio receivers and transmitters, optical devices, cameras, etc.). The balloon inflation system may also include a controller 26 configured with the payload 24 or as part of the balloon inflation system.

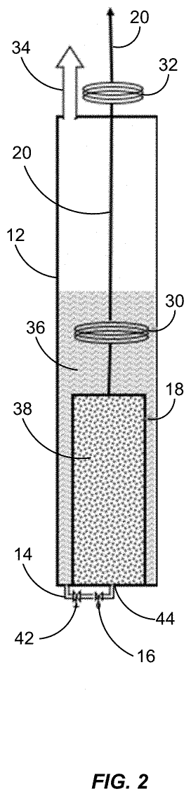

FIG. 2 is a more detailed block diagram of the exemplary balloon inflation system. In this embodiment, the reactor 18 is configured within the water tank 12. And, as one example, the reactor 18 is configured with a material 38 that comprises NaBH₄. The water 36 within the water tank 12 is operable to serve more than one purpose. For example, the water 36 may be fed into the reactor 18 via the water line 14 that fluidly couples the water tank to an inlet 44 of the reactor 18. When valves 42 and 16 are opened, water flows into the reactor 18 and reacts with the material 38 to produce the lift gas. And, as the reaction between the water and the material 38 may produce intense heat, the water 36 remaining in the water tank 12 is operable to cool the reactor 18.

The system may also provide other cooling measures such as the cooling loops 30 and 32. The cooling loop 30 may assist in cooling the water 36 as it is heated by the reaction in the reactor 18. And the cooling loop 32 is operable to cool the lift gas as the lift gas is exhausted via the exhaust 20 into the balloon 10 (not shown). The system may also include a vent 34 that allows steam generated by the reaction to vent from the system.

As mentioned, in this embodiment, the material 38 may comprise NaBH₄ so as to produce a lift gas of hydrogen from the reaction with water. To produce hydrogen, one mole of NaBH₄ is combined with two moles of water as follows:

NaBH₄+2H₂O_{(I)}=>NaBO₃+4H₂, with a ΔH=−300 kJ/mole.

Each mole of NaBH₄ has a mass of 38 gm. When reacted with 36 gm of water, it produces 4 moles of hydrogen, having a mass of 8 gm. The hydrogen displaces four moles, or 116 gm of air, producing a net buoyancy of 108 gm, nearly three times the mass of the NaBH₄. Thus, each kg of NaBH₄ can be combined with 0.95 kg of water to produce 2.84 kg of lift. And to create 3 kg of lift, 1.05 kg of NaBH₄ and 1 kg of water is needed.

When a total of 27.63 moles of NaBH₄ is used, the reaction can produce 8289 kJ of energy. Divided over a 300 second inflation time, the average power released is about 27.6 kWt. If the reactor were not cooled, its temperature would rise to over 900° C. While a steel shell reactor could withstand this, such a temperature rise could cause decomposition of the NaBH₄ powder in the reactor 18, which could block the flow of the lift gas. Hence, it is desirable to cool the system. While significant air cooling can be achieved as the units drops at 5 m/s through the cold upper atmosphere, one method of cooling is immersing the reactor vessel (i.e., reactor 18) in a water bath. The vaporization of cold water generally requires 2.688 kJ/gm. So, all the heat produced in the reactor 18 could be removed by vaporizing 3.08 kg of water. Thus, 4 kg of water in total is needed to operate this “baseline system” (e.g., 1 kg for reactant and 3 kg of water for cooling). In some embodiments, the amount of water is doubled to provide a surplus. This ensures that the coolant does not run out, and allows the hydrogen product to flow through a coil in the water bath, cooling it to about 100° C. before the lift gas is sent through the air cooling radiator coil to reduce the lift gas to ambient temperatures prior to delivery to the balloon 10.

The density of NaBH₄ powder is about 0.7 gm/cc. To accelerate the reaction, the NaBH₄ may be mixed with H₃BO₃ powder, which has a density of about 0.8 gm/cc, with about 1.5 times as much H₃BO₃ as NaBH₄ by weight in the mixture. It thus requires about 3.6 cc of reactor volume to contain each gm of NaBH₄. To contain the 1.05 kg of NaBH₄, the baseline system will need to have a reactor 18 with about 8 liters in volume, including 3.8 liters for the powder plus ample space for the water and reaction zone. The reactor 18 is configured in a 20 liter (e.g., 5 gallon) water vessel. Of course, these values can be changed as desired. And, in other embodiments shown and described below, the material 38 may differ in the reaction to provide the lift gas.

In some embodiments, the reactor 18 is an 8 liter NaBH₄ reactor vessel 15 cm in diameter and 45 cm long and is contained in a 20 liter water tank 12 that is 20 cm in diameter and 64 cm long. The water 36 is fed from the water tank 12 into the reactor 18 through the fluid coupling 14. Generally, the water tank 12 is not filled with water 36 until deployment. The valve 42 in this embodiment is an optional safety valve that is not opened until immediately before the parachute drop.

The electronic control valve 16 generally opens after parachute deployment, but the control valve 16 could be configured to allow a certain amount of water to flow before it closes, which could be useful for payloads of different sizes.

Once water enters the reactor 18, it will react with the NaBH₄ and rapidly heat the reactor 18, which in turn will warm the surrounding water bath 36. Once the water 36 starts to boil, the water 36 will generate steam which can be released via a relief valve 34 in the top of the water vessel 12 surrounding the reactor 18. Thus, surrounded by a boiling water bath 36, the reactor shell temperature can be held to about 100° C. The interior of the reactor 18 will generally be hotter, however, when the hydrogen lift gas exits the reactor 18. So, the hydrogen lift gas is passed through a cooling tube 30 immersed in the water, reducing the temperature of the lift gas to about 100° C. before it exits the reactor 18. Alternatively, the hydrogen lift gas could be sent to a separate condenser vessel made of a highly heat-conducting material like copper or aluminum, immersed in water. Further cooling of the hydrogen lift gas can be performed with an air-cooled radiator (e.g., the cooling loop 32) before it is delivered to the balloon 10. Assuming the mass of metal components of the system (e.g., the water tank 12 and the reactor vessel 18) are about 3 kg, the total mass of the entire baseline PBLS, including water, NaBH₄, gondola and balloon, is about 14 kg. This represents about 1/10^{th} the payload capability of a man-rated parachute. So, this baseline PBLS could be scaled up by a factor of ten to support 20 kg gondolas and still be deliverable using a standard individual parachute.

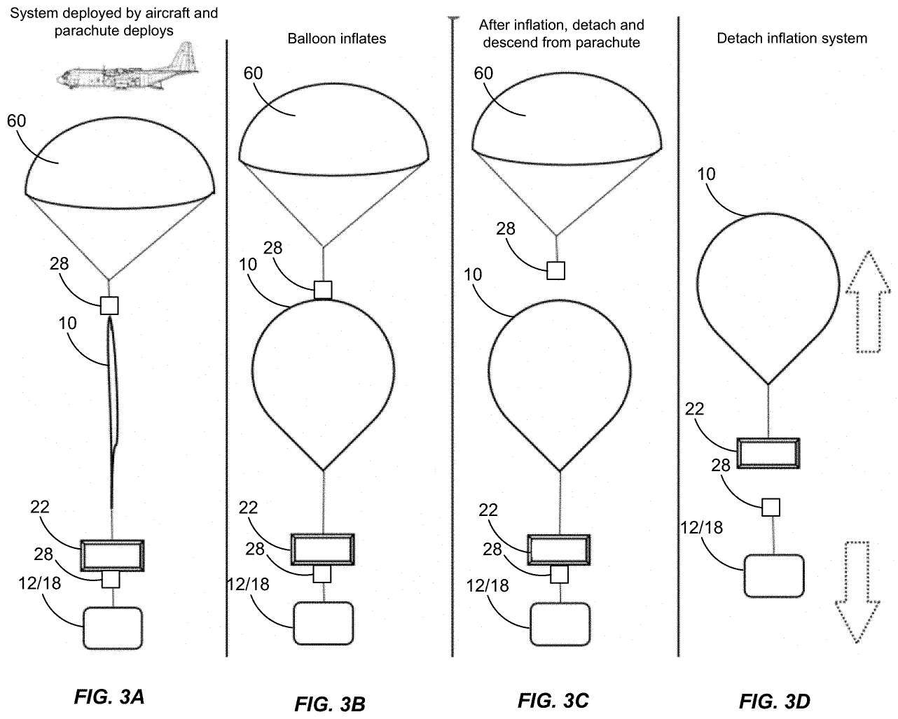

FIGS. 3A-3D exemplarily illustrate a deployment of the PBLS with a parachute 60. Deployment of the PBLS initiates when a package containing a parachute 60, an uninflated balloon 10, a payload gondola 22, and the balloon inflation system (i.e., the water tank 12, the reactor 18, water, reactant, control system, valves, etc.) is dropped from a piloted or drone aircraft, as illustrated in FIG. 3A. The parachute 60 then deploys, slowing the descent of the PBLS to a velocity of about 5 m/s (˜1000 ft/min). Once this condition is reached, the inflation system may be activated (e.g., either by a sensor trigger or remote control), producing hydrogen lift gas via the reaction of water with a strong reducing agent, such as NaBH₄, LiH, or Na₂Si₂, as illustrated in FIG. 3B.

Balloon inflation generally takes about 5 minutes, during which time the PBLS will have descended about 5,000 feet. Once inflation is completed, the parachute separates from the PBLS, as shown in FIG. 3C (e.g., via a release mechanism 28). Afterwards, the balloon inflation system may separate from the PBLS, as shown in the FIG. 3D. For example, since the gondola is still attached to the balloon inflation system and the parachute 60 is almost without payload, the balloon inflation system falls faster than the parachute 60, allowing separation of the parachute 60 to occur. After about ten seconds of falling away from the parachute 60, sufficient distance to preclude subsequent interference between the parachute 60 and the balloon inflation system will have been achieved. The balloon inflation system may then be detached from the PBLS (e.g., via another release mechanism 28), giving the PBLS positive buoyancy. The PBLS may then ascend to a relatively high altitude (70,000 to 100,000 ft) to conduct its mission based on the type of payload 24 in the gondola 22. It should be noted that the PBLS may be dropped from as low as 6,000 ft or as high as any airplane can fly and still deploy and then ascend to its operational altitude. The release mechanisms may be electronically and/or wirelessly controlled by the controller 26.

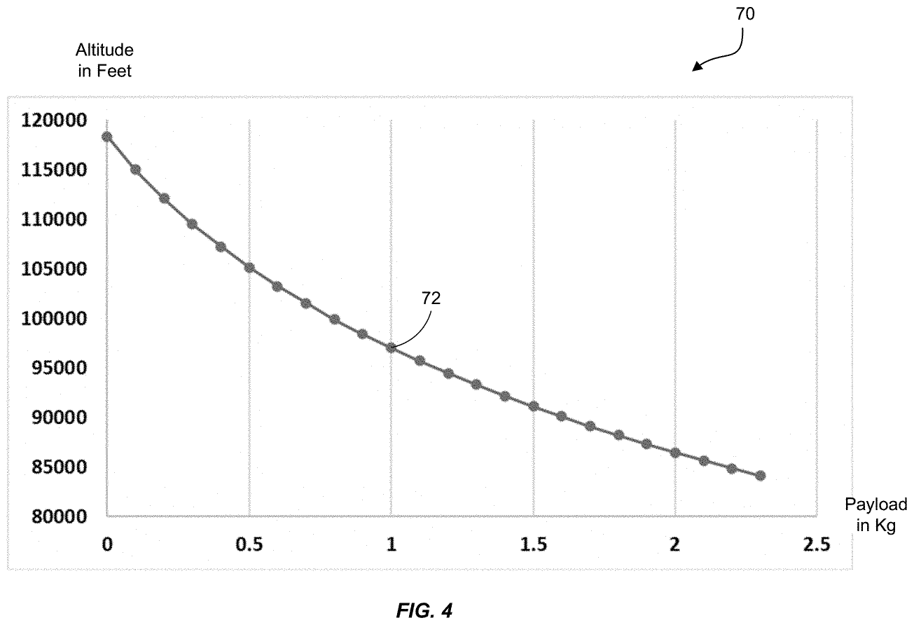

Generally, this baseline PBLS can produce enough hydrogen to provide 3 kg worth of lift. Employed together with a 600 gm latex balloon, the PBLS can fly gondola payloads of up to 2.3 kg (roughly 5 lbs.) up to 84,000 ft, 1 kg to 97,000 ft, or 0.1 kg up to 115,000 ft. The payload capability of the baseline PBLS system as a function of altitude is shown in graph 70 of FIG. 4, with the plot line 72 illustrating various payloads at certain altitudes. Thus, the payload capability of the PBLS is more than sufficient for radio repeaters and many other functions of interest, such as sensors, optical systems, radar, telemetry, communication systems, and the like. Larger payloads are also possible using larger versions of the PBLS system, which could readily be built by multiplexing and/or enlarging this baseline PBLS.

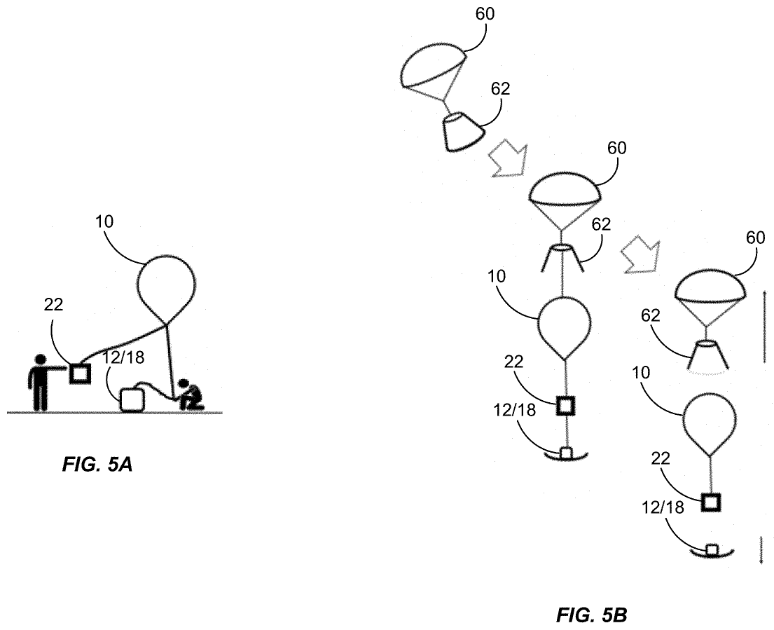

The PBLS has been designed with capability for air launch in mind. But modified versions of the technology could be used to support ground launch applications, sea launch, submarine launch or even space launch applications. Some examples of these are illustrated in FIGS. 5A and 5B.

In the case of a ground launch, the system may be simplified (FIG. 5A), as there is no need for parachute deployment and the safety valve can be opened manually. The PBLS can be restartable. Ideally, the reactor vessels containing reactant powder could be attached or removed from the rest of the PBLS at will like cartridges, while the water feed tanks can be refilled, making the PBLS rapidly reusable, or allowing a small unit to inflate a larger balloon than it could using a single charge. This would allow a ground team, such as military special forces, to take the 3 kg apparatus with them on a mission along with four 1.5 kg cartridges each containing 600 gm of NaBH₄ and 900 gm of H₃BO₃. Water could be obtained from local sources to start the reaction in the reactor 18. Each cartridge would produce 1.6 kg of lift. Using 300 gm balloons, the ground team would then be able to launch a total of eight 0.3 kg payloads 22, such as radio repeaters, to support their operations over the course of their mission. Ground launch systems could also be used at remote stations to launch large numbers of radiosondes, which provide wind data useful to aviation, space launches, and artillery operations.

For space launch applications (FIG. 5B), the PBLS could be contained in a reentry capsule 62 and released from an orbital spacecraft or a ballistic missile. After reentry and deceleration, the capsule 62 would deploy a parachute and slow to terminal velocity. The parachute 60 would then be used to pull the back shell off the capsule 62, pulling out the balloon 10 and gondola 22. The balloon inflation system 12/18 could also be pulled out and off the heat shield, or remain on it. Either way, inflation would begin after the balloon inflation system 12/18 is pulled out of the capsule 62, with the rest of the PBLS deployment sequence following that of an air launch operation, as described above.

The space launch system involves several challenges in addition to those of the air launched PBLS. For example, mass and volume constraints are likely to be tighter, potentially limiting the PBLS units to a smaller size. Also, the water would have to be in the PBLS unit at the time of launch. This presents no problem to PBLS units launched by ballistic missile, but PBLS units placed in orbit for an indefinite period of time before use would have to address the issue of potential freezing of the water. Possible means of solving this could include maintaining a controlled temperature within the capsule, putting some methanol in the water to lower the freezing point to prevent freezing, use of reentry heat, and/or a set of batteries to melt enough of the ice to initiate operation, after which heat of reaction could melt the rest.

While not trivial, these challenges all appear solvable. The resulting space launched PBLS systems could provide the military with the ability to instantly deploy a communication and/or reconnaissance high altitude platforms nearly anywhere in the world where they might be needed.

While many of the functions of balloon-lofted payloads can be performed by satellites, the number of satellites available is limited, their movements are predictable, and only low Earth orbiting (LEO) satellites remain near an area of operational interest for a period of minutes. In contrast, balloons are at least three orders of magnitude cheaper than satellites, and can thus be deployed in much greater numbers. Additionally, balloons can be deployed almost anywhere on demand, so their arrival or presence is not as predictable by an adversary. And, instead of remaining within an operational area of interest for minutes like a satellite, a balloon payload can remain over an operational area of interest for hours.

Consider, for example, a military special forces team that needs to establish a communications link to other units, or talk to or coordinate air traffic around its location. Instead of having to wait for a satellite or a drone to arrive to assist them, the team could launch its own high altitude balloon communication link. Alternatively, if special forces team is being assisted by a drone, the drone could drop off a balloon to allow communication to continue after the drone needed to fly away to another location. Moreover, a drone or piloted aircraft could drop off a string of balloon platforms along its line of flight, providing services to many units and/or establishing communication across a wide region.

The PBLS could also be used to assist strike operations. For example, at the same time that paratroopers are being deployed from an aircraft, a PBLS could also be released, providing the paratroopers with a communication link system to assist them even before they reach the ground. An PBLS could also be released by a fighter or a bomber taking part in an air raid, with the PBLS package providing cameras for after action imaging and/or a receiver for listening to radio chatter that could assist with the evaluation of the air raid and/or planning for the next air raid. Radar or infrared sensing systems carried by the PBLS could also serve as warning devices, providing advance notice of an air operation launched by an adversary.

The PBLS could also provide a very responsive reconnaissance system. For example, an aircraft could be flown at night outside and upwind of the border of a nation of interest to release an PBLS. The aircraft could then fly away while the balloon ascended to 100,000 ft to spend the next day overflying the region to be surveyed.

PBLS could also be of immense value to naval operations. For example, a submarine could launch the PBLS by releasing a package that would float to the surface and inflate a balloon carrying a communication link to high altitude. The submarine could then send up a radio buoy and use the balloon gondola radio relay floating at 100,0000 ft to communicate with distant forces. Submarines can achieve the same now using satellite links, but they would not have to wait for a satellite in order to initiate communication with the PBLS. And a submarine's ability to communicate could continue even if an adversary destroyed the satellite.

Regarding the balloons, there are generally three types: latex (“rubber”) balloons; zero pressure balloons; and super-pressure balloons.

Latex balloons are used every day in large numbers to launch radiosondes. Such balloons are generally in the 300 gm class, and could be used to launch payloads up to 1 kg to very high altitudes. These balloons are relatively easy to launch since they are compact, only expanding to a large size as they reach high altitude. One downside of latex balloons from a military point of view is that they expand indefinitely as they ascend until they reach a burst altitude. At a typical ascent rate of 1000 ft/min, this generally means their flight lifetime is limited to about 100 minutes. For many applications, such as radiosondes, this is perfectly fine, but it may be limiting for other applications.

The flight duration of a latex balloon could be extended by reducing the rate of ascent. This could be possible with the PBLS system, because unlike a simple radiosonde in which the balloon is tied closed, the balloon could retain its inflation tube to be reopened to vent gas at altitude. Thus, for a balloon with a burst altitude of 90,000 ft, the PBLS could ascend at 1,000 ft per minute until it reaches 70,000 ft, and then vent sufficient gas to slow its rate of ascent to 50 ft/min. In such a case, the PBLS would have about 400 minutes of flight as opposed to having 20 minutes of flight over 70,000 ft. And these balloons are relatively inexpensive.

Zero pressure balloons are more sophisticated. These balloons are made of polyethylene, and are considered the “workhorses” for scientific ballooning. These balloons generally cost thousands to tens of thousands of dollars each, depending on size. But, instead of bursting at their maximum float altitude, zero pressure balloons will simply stop ascending at that altitude and float. One problem is that these balloons lose buoyancy at sundown and eventually descend to the ground. Thus, if one launches a zero-pressure balloon at night, the balloon can float all night and the following day before it falls on the next night. However, the flight can be extended by either dropping ballast or having the PBLS routinely generate lift gas as needed (e.g., via the controlled operation of the valve 14).

The most sophisticated type of balloon is the super-pressure balloon. These balloons are generally spherical and made of mylar, nylon, or the like that allow them to be strong enough to retain pressure generated in a fully filled balloon at sunrise. As a result, super-pressure balloons can be fully inflated at sundown without the need to generate replacement gas or without the need to drop ballast. In principle, super-pressure balloons can fly for exceptionally long periods of time (e.g., 900 days). Larger super-pressure balloons do leak, however, and would therefore likely require ballast dropping and/or the PBLS to remain afloat. Still, large balloons (e.g., roughly 2000 kg class payloads) could be achieved. And, while super-pressure balloons can cost millions of dollars, super-pressure balloons are still much cheaper than satellites.

Super-pressure balloons are designed for long duration flights at constant altitude. Super-pressure balloons can orbit the Earth by riding prevailing winds, essentially acting as inexpensive satellites. In contrast, zero pressure balloons offer shorter duration, but zero pressure balloons can be made to maneuver by changing their altitude to ride in winds going in a preferred direction. As mentioned, changing altitude generally requires producing gas, venting gas, and/or dropping ballast. By producing gas, an PBLS can provide roughly triple the amount of buoyancy changing capability for a given amount of consumable mass when compared to systems that vent gas and/or drop ballast.

While the systems and methods herein describe the use of NaBH₄ as the reductant material 38, other reductants, including powders of metals such as aluminum, magnesium, and silicon, can be used in the reactor 18 of the PBLS. A table of exemplary reductants is shown below:

| Reductant | Melting point | Product | # Waters | # H2s | Net Heat Mass/mol | | H/M by wt | kJ/H2 |
|---|---|---|---|---|---|---|---|---|
| Fe | 1538 | H2 + FeO | 1 | 1 | −13 | 56 | 0.036 | −13.00 |
| 2Fe | 1538 | 3H2 + Fe2O3 | 3 | 3 | −32 | 112 | 0.054 | −10.67 |
| Si | 1414 | 2H2 + SiO2 | 2 | 2 | 339 | 28 | 0.143 | 169.50 |
| Mg | 650 | H2 + MgO | 1 | 1 | 321 | 24 | 0.083 | 321.00 |
| Ti | 1668 | 2H2 + TiO2 | 2 | 2 | 373 | 48 | 0.083 | 186.50 |
| Zn | 419 | H2 + ZnO | 1 | 1 | 64 | 65 | 0.031 | 64.00 |
| 2B | 2076 | 3H2 + B2O3 | 3 | 3 | 416 | 22 | 0.273 | 138.67 |
| 2(LiH) | 689 | 2H2 + Li2O | 1 | 2 | 128 | 16 | 0.250 | 64.00 |
| 2(NaH) | 636 | 2H2 + Na2O | 1 | 2 | 18 | 48 | 0.083 | 9.00 |
| NaH | 636 | H2 + NaOH | 1 | 1 | 84 | 24 | 0.083 | 84.00 |
| MgH2 | 327 | 2H2 + MgO | 1 | 2 | 246 | 26 | 0.154 | 123.00 |
| TiH2 | 350 | 3H2 + TiO2 | 2 | 3 | 231 | 50 | 0.120 | 77.00 |
| Na2Si2 | 1100 | 5H2 + Na2O + 2SiO2 | 5 | 5 | 175 | 102 | 0.098 | 35.00 |
| CaSi2 | 900 | 5H2 + CaO + 2SiO2 | 5 | 5 | 827 | 96 | 0.104 | 165.40 |
| Mg2Si | 1100 | 4H2 + 2MgO + SiO2 | 4 | 4 | 961 | 76 | 0.105 | 240.25 |
| 2(FeSi2) | 1220 | 11H2 + Fe2O3 + 4SiO2 | 11 | 11 | 1243 | 224 | 0.098 | 113.00 |
| MgB2 | 830 | 4H2 + MgO + B2O3 | 4 | 4 | 645 | 46 | 0.174 | 161.25 |
| TiB2 | 3230 | 5H2 + TiO2 + B2O3 | 5 | 5 | 510 | 70 | 0.143 | 102.00 |
| SiB6 | 1950 | 11H2 + SiO2 + 3B2O3 | 11 | 11 | 1503 | 88 | 0.250 | 136.64 |
| NaBH4 | 400 | 4H2 + NaBO2 | 2 | 4 | 304 | 38 | 0.211 | 76.00 |
| LiBH4 | 268 | 4H2 + LiBO2 | 2 | 4 | 251 | 23 | 0.348 | 62.75 |
| LiAlH4 | 150 | 4H2 + LiAlO2 | 2 | 4 | 500 | 38 | 0.211 | 125.00 |
| B4C | 2763 | 8H2 + 2B2O3 + CO2 | 8 | 8 | 574 | 55 | 0.291 | 71.75 |

With these reductants, it is assumed that the reductant is reacting with liquid water, not steam. The information in the table in the two columns on the far right shows the mass of hydrogen produced per mass of reactant and the amount of energy released per mole of hydrogen. It is generally desirable that the mass of hydrogen per mass of reactant be high to reduce the amount of reactant required. But the energy released per mole should be low to reduce the amount of coolant required.

It can be seen in the table that, with the exception of elemental boron, the pure elemental metals are inferior performers, producing significantly less hydrogen per unit weight than the compound alternatives. Boron, however, releases a lot of energy, creating high coolant requirements. Iron releases negative energy, which means that it will not react with liquid water. Iron will, however, react with steam. Iron is inexpensive, but iron is also heavy and generally inferior for use in a PBLS.

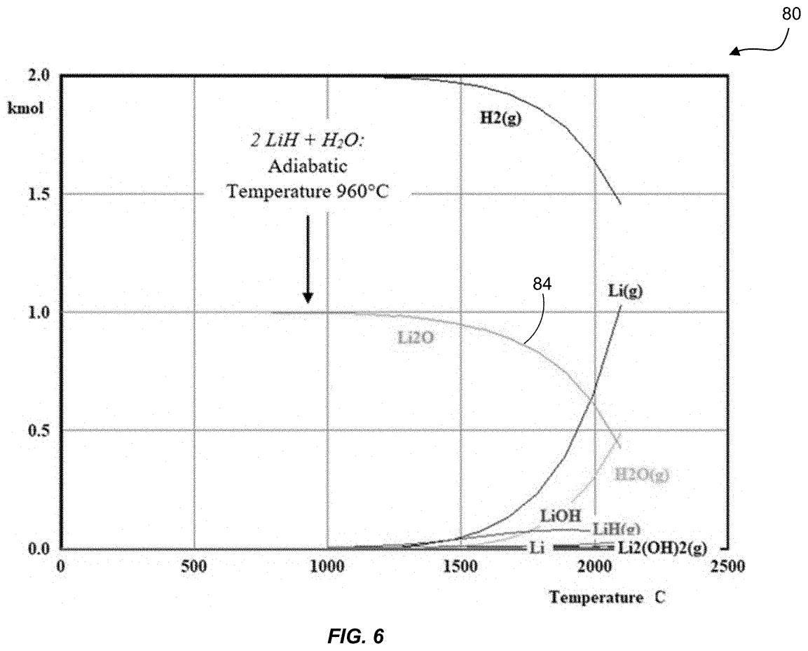

The highest hydrogen yield per reductant mass is LiBH₄. This compound has a melting point of 268 C. Low melting points combined with large energy yields also militate against MgH₂ and LiAlH₄. However, if sufficient water cooling is available, all of these are usable. CaSi₂ has a modest hydrogen yield and relatively high energy, while being inexpensive and safe. Na₂Si₂ provides moderate hydrogen yield per unit mass, but low cooling requirements. TiB₂ and SiB₆ provide relatively good hydrogen yields and have very high melting points. Even though TiB₂ and SiB₆ require significant cooling, they could be used. LiH provides a relatively high hydrogen yield, a moderate energy release, and a fairly high melting point. So, LiH could be used in the PBLS provided that the reaction goes to completion to Li₂O as shown in the table and does not end at LiOH. Analysis reveals this should be the case, as shown with the plot line 84 in the graph 80 of FIG. 6. The uncooled reaction temperature is about 960° C., but the use of water cooling can reduce the temperature below 300° C.

Hydrogen generates 13.5 times its own mass in net lift. Considering the values in the “H/M by weight” column of the table above, and multiplying those values by 13.5, one obtains the total lift in kilograms that can be obtained for each kilogram of the reductant listed.

Another reductant is boron carbide, B₄C. Boron carbide is a safe and inexpensive material, widely used as an abrasive. B₄C can be made to react with steam, which can be generated by the heat of reaction itself. The ideal reaction equation is:

B₄C+8H₂O_{(I)}=>2B₂O₃+CO₂+8H₂, with a ΔH=575 kJ/mole.

Analysis shows that results are close to those indicated by the reaction and should be obtainable in practice. The heat of the reaction is 72 kJ/mole of hydrogen. Without cooling, the temperature of the reactor 18 and its output gases are driven to about 1050° C. This, however, is well below the melting point of both B4C (2700° C.) and steel (1500° C.), so the reactor 18 does not need to be cooled. Rather, only the output hydrogen should be cooled. To produce 112 moles of hydrogen in 5 minutes, disposal of 8050 kJ is needed, or a cooling rate of 27 kWt. One way to do this is to pass the hydrogen exhaust through a copper coil immersed in water. Boiling 1 gm of water requires 2.7 kJ. So, this amount of heat can be disposed of by vaporizing 3 kg of water. This will lower the hydrogen temperature to about 100° C., after which further cooling can occur as the gas traverses the inflation tube to the balloon. A total of 2 kg of water is generally needed to react with 770 gm of B4C to produce the amount of hydrogen gas needed to provide 3 kg of buoyancy. Boron carbide has a density of 2.5 gm/cc. So, assuming that a reactor bed is filled with grains of B4C with a bulk density of half this, the required reactor 18 would have a volume of 620 cc. Thus, a PBLS using B₄C could be quite compact. And the hydrogen to reductant mass ratio would also be a very preferable 0.29.

Yet another method of hydrogen reduction is to use the heat of reaction to drive the endothermic dissociation of hydrides. For example, reacting MgH₂ with H₂O at the stoichiometric 1:1 ratio produces hydrogen gas at 1900° C. If the reaction is 3MgH₂ with 1 H₂O, most of the energy of the reaction is consumed dissociating MgH₂ into its elemental constituents, and the hydrogen gas is produced at a temperature of about 350° C. This reaction is as follows:

3MgH₂+H₂O=>MgO+2Mg+4H₂, with a ΔH=−96 kJ/mole

This reaction produces 24 kJ per moles of hydrogen yield, about ⅓ of that produced by an PBLS using NaBH₄. But this reduces the amount of water needed to cool the hydrogen produced by a factor of three. The reactor temperature is also low enough to remove the need for a water-cooling jacket. However, the hydrogen yield per unit mass of the reactant is only 0.1025, about half as much as that produced by an PBLS using NaBH₄. This type of PBLS could provide for a much simpler system. Similar methods, using the endothermic heat of dissociation of excess reactant to cool the output gas could be done using TiH₂, NaBH₄, LiBH₄, LaAlH₄, NaAlH₄, CaH₂ or other hydrides.

Another method of cooling is to include some methanol or ammonia with the water, and consume heat using the endothermic methanol or ammonia dissociation reactions. Still another method could include using ammonia instead of water as a reactant, producing nitrides instead of hydrides as products. For example, reacting ammonia with a mixture of magnesium and magnesium hydride is as follows:

Mg+2MgH₂+2NH₃=>Mg₃N₂+5H₂, with a ΔH=−15 kJ/mole

In this case, the heating produced is relatively insignificant such that no cooling may be required at all. Such a system might be particularly advantageous for a unit designed for deployment from orbital assets.

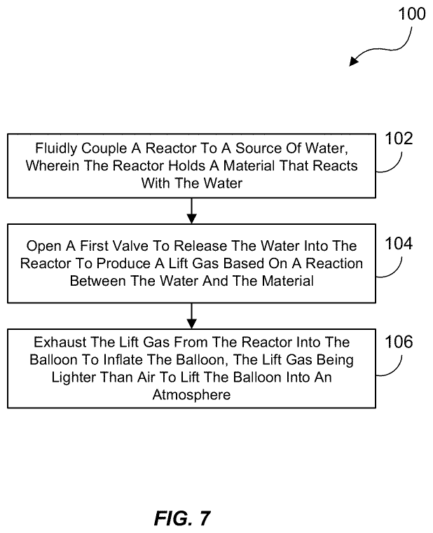

FIG. 7 is a flow chart of an exemplary process 100 for generating a lift gas to inflate a balloon 10. In this embodiment, a source of water is fluidly coupled to the reactor 18, in the process element 102. The reactor 18 holds a material that reacts with the water from the water source, as described above. Then, a first valve may be opened to release the water into the reactor 18 to produce a lift gas based on a reaction between the water and the material, in the process element 104. This lift gas is then exhausted from the reactor 18 into the balloon 10, in the process element 106. As the lift gas is lighter than air, the lift gas lifts the balloon into the atmosphere.

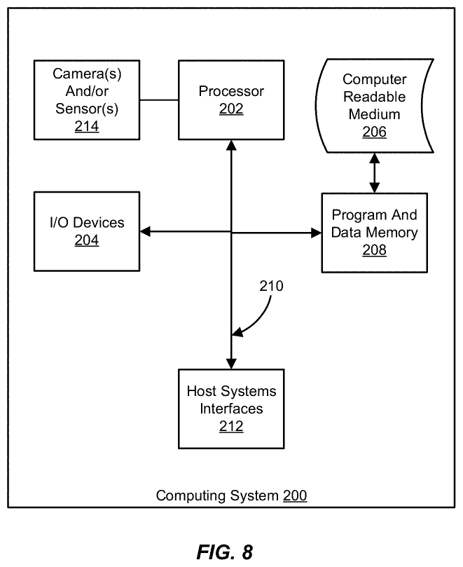

Any of the above embodiments herein may be rearranged and/or combined with other embodiments. Accordingly, the invention is not to be limited to any particular embodiment disclosed herein. Additionally, the invention can also take the form of an entirely hardware embodiment or an embodiment containing both hardware and software elements. For example, a controller could be programmed to detect altitude, temperature, and/or velocity sensors so as to initiate balloon inflation, control valves that assist in the reaction, detach a parachute, detach the reactor 18 and the water tank 12 upon inflation, and the like. FIG. 8 illustrates a computing system 200 in which a computer readable medium 206 may provide instructions for performing any of the methods disclosed herein.

Furthermore, some aspects of the embodiments herein can take the form of a computer program product accessible from the computer readable medium 206 to provide program code for use by or in connection with a computer or any instruction execution system. For the purposes of this description, the computer readable medium 206 can be any apparatus that can tangibly store the program code for use by or in connection with the instruction execution system, apparatus, or device, including the computing system 200.

The computer readable medium 206 can be any tangible electronic, magnetic, optical, electromagnetic, infrared, or semiconductor system (or apparatus or device). Some examples of a computer readable medium 206 include solid state memories, magnetic tapes, removable computer diskettes, random access memories (RAM), read-only memories (ROM), magnetic disks, and optical disks. Some examples of optical disks include read only compact disks (CD-ROM), read/write compact disks (CD-R/W), and digital versatile disks (DVD).

The computing system 200 can include one or more processors 202 coupled directly or indirectly to memory 208 through a system bus 210. Additionally, the computing system 200 may have one or more cameras and/or sensors 214 coupled to the processor(s) 202 to perform in accordance with the embodiments disclosed hereinabove. The memory 208 can include local memory employed during actual execution of the program code, bulk storage, and/or cache memories, which provide temporary storage of at least some of the program code in order to reduce the number of times the code is retrieved from bulk storage during execution.

Input/output (I/O) devices 204 (including but not limited to keyboards, displays, pointing devices, I/O interfaces, etc.) can be coupled to the computing system 200 either directly or through intervening I/O controllers. Network adapters may also be coupled to the computing system 200 to enable the computing system 200 to couple to other data processing systems, such as through host systems interfaces 212, printers, and/or or storage devices through intervening private or public networks. Modems, cable modems, and Ethernet cards are just a examples of network adapter types.

### Examples of PBLS Designs and Operations

To demonstrate the feasibility of the PBLS, several prototype units have been built and tested. In one exemplary embodiment, a PBLS is capable of producing 10 kg of lift gas. Other exemplary embodiments include a capability of 4 kg of lift gas and 1.4 kg of lift gas. All of these units employed the reaction of water with sodium borohydride (NaBH₄) to produce hydrogen gas. In order to accelerate the reaction, boric acid (H₃BO₃) powder was mixed with the NaBH₄ powder prior to the introduction of water into the system. In the experiments done, the ratio of H₃BO₃ to NaBH₄ in the mixture was 1.5:1 by weight.

The payload capability of the 1.4 kg of lift gas PBLS embodiment is more than sufficient to launch radiosondes and radio repeaters and many other functions of interest to 100,000 ft. The larger units can launch bigger payloads, including gliders capable of precision reconnaissance and strike. Proof of principle demonstration flights showing the feasibility of this concept were performed using the 4 kg of lift gas PBLS embodiment.

The 1.4 kg of lift gas PBLS embodiment is 4″ in diameter and 12″ long. The 4 kg of lift gas PBLS embodiment is roughly 6″ in diameter and roughly 18″ long. The 10 kg of lift gas PBLS embodiment is roughly 8″ in diameter and roughly 24″ long. All were made of aluminum.

During operation, each unit is cooled by being immersed in a water container. The 1.4 kg of lift gas PBLS embodiment is generally designed for special forces in mind can be disassembled to fit in a backpack. Reactant water is contained in the vessels on top of the reactors. To generate gas, the operator simply opens the valve between the feed water vessel and the reactor. Condensers are configured with each unit.

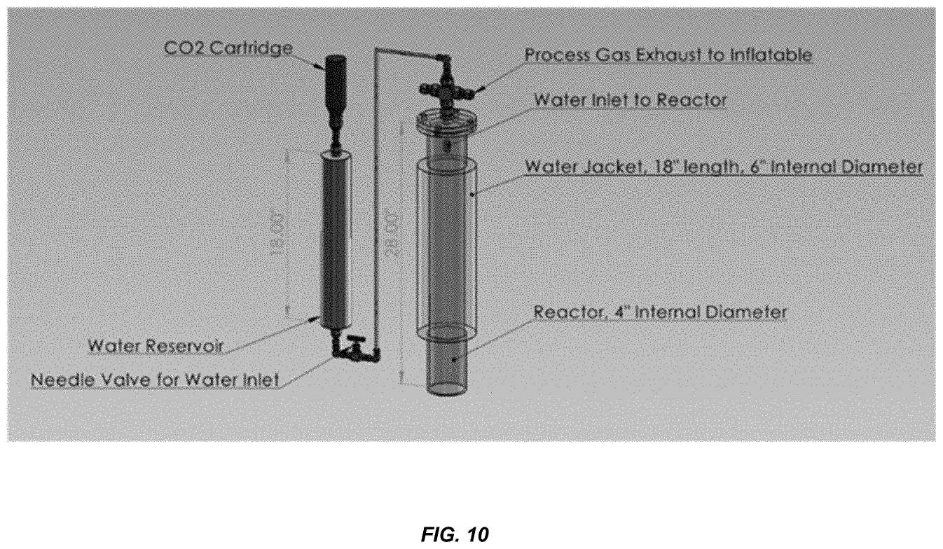

FIG. 10 illustrates the 10 kg of lift gas PBLS embodiment. The reactor (bottom right, roughly 8″ in diameter and roughly 24″ long) and the condenser are each immersed in tubs of water to provide cooling. The feed water tank is above the reactor. Flow from the feed tank to the reactor is controlled by a valve on the line connecting them directly at their centers. A secondary line between the feed water reservoir tank and the reactor keeps pressure between them equal, allowing gravity feed of water to proceed regardless of reactor pressure. All primary components were made of aluminum, except the water tubs which are commercially available trash bins.

The exit from the condenser includes two 25 lbf check valves, connected in parallel so that if one sticks shut gas, can still flow through the other. If both stick shut, there is a manual valve the operator can open to ensure that the reactor does not over pressurize. Pressure can be read using a steam gauge on top of the reactor. The system also has a pressure relief valve to save the system should both check valves stick and the operator fails to make use of the manual valve. A clamp system around the top of the reactor allows it to be open for quick loading or unloading.

This prototype of the PBLS uses the reaction of water with NaBH₄ (a widely used industrial reducing agent, produced in large quantities in the USA and elsewhere around the world) to produce hydrogen, as follows:

NaBH₄+2H₂O_{(I)}=>NaBO₃+4H₂, with a ΔH=−300 kJ/mole

Each mole of NaBH₄ has a mass of 38 gm. When reacted with 36 gm of water it produces 4 moles of hydrogen, having a mass of 8 gm. The hydrogen displaces four moles, or 116 gm, of air, producing a net buoyancy of 108 gm, nearly three times the mass of the NaBH₄. The NaBO₃ is a salt that remains in solution. Thus, each kg of NaBH₄ combines with 0.95 kg of water to produce 2.84 kg of lift. To create 1.4 kg of lift, one would therefore need 0.5 kg of NaBH₄ and 0.5 kg of water. In order to accelerate the reaction, 0.75 kg of boric acid (H₃BO₃) powder is mixed with the NaBH₄. This mixture will react spontaneously with water at any temperature, eliminating the need for any heating system to initiate the reaction.

NaBH₄ will not react significantly with room temperature water without boric acid powder being mixed in. All three reactants (NaBH₄, Boric acid, and water) need to be present for spontaneous reaction to occur. The amount of reaction that then occurs is proportional to the water provided. If a few drops of water hit the mixed powder, they do not “set off” a reaction. Instead, only a trivial amount of reaction will occur. These are important safety features of the PBLS system.

A total of 13.2 moles of NaBH₄ are used to generate 1.4 kg of lift. This will produce 4140 kJ of energy. Divided over a 300 second inflation time, the average power released will be 13.8 kWt. This will produce about 1.5 moles of steam for every mole of hydrogen. This steam needs to be condensed. When used in a ground launch application, this can easily be accomplished by inserting the unit reactor and condenser in tubs of water. The reactors are pressurized by redundant check valves connected in parallel over the condenser exit.

There is also a manual pressure release valve as a back-up. In the reactor, 25 psi check valves are used. Together with the pressurization caused by the high gas flow through the balloon inflation tube, these send the pressure in the reactor and condenser system to about 40 psig. At this pressure, steam condenses at 140° C., which is much higher than the boiling point of water at sea level, so that even if the water in the reactor cooling tub was boiling, the steam generated by the heat of reaction would be readily condensed in the reactor, which is made of aluminum, and is thermally transparent. Residual water vapor in the hydrogen product is condensed in the condenser, which remains cool. Depending on the size of the water tub the water temperature might typically only rise to about 60° C. by the end of the reaction.

### PBLS Units for Air Launch of Balloons

Because of its simplicity, the PBLS offers promise for use in air launch of balloons. In such operation, the PBLS and balloon could be dropped from a piloted aircraft or drone, after which a parachute would deploy. The line from the water reservoir to the balloon would then be opened, causing inflation to initiate. Inflation can be accomplished within 5 minutes, and the parachute descent rate would be about 1000 ft/min. Air drop deployment of the balloon can therefore be accomplished at altitudes as low as 6,000 ft AGL. Once inflation is completed, the PBLS/balloon package would cut away from the parachute. It would then drop faster than the chute, enabling separation. Then the PBLS system would be dropped by the gondola, allowing the balloon and gondola to achieve positive buoyancy. The balloon and the gondola would then float up to the stratosphere to accomplish its mission. The air launch sequence of operations is shown and described above in FIGS. 4A-4D.

While ample tubs of water can be used for cooling of ground launch systems, for air launch it is desirable to reduce the mass of cooling water required. This can be accomplished by operating the system at high pressure. For example, at 100 psig, the boiling point of water is around 180° C., while the boiling point of water at 18,000 ft is only 80° C. The air launch version of the PBLS therefore surrounds a pressurized reactor with a built-in water bath which is allowed to boil at ambient pressure. This greatly increases the cooling capacity of the water bath, since it takes about ten times as much energy to boil a given mass of water as it does to raise it to 64° C. A design for such a system is shown in in FIG. 10.

In this embodiment, the prototype air launch PBLS inflation system is contained in a 3.8-liter water tank that is 14 cm in outer diameter, 10 cm inner diameter, and 46 cm long. A 5.6 liter NaBH₄ reactor vessel 10 cm in diameter and 71 cm long is configured therein. In the prototype air launch design depicted in FIGS. 4A-4D, water is fed into the reactor from a tank pressured by a CO₂ cartridge. This allows the reactor to operate at a higher pressure than the coolant, which has an open steam vent to the atmosphere.

Subsequent to this design, the system was altered to include a line allowing the reactor product gas to pressurize the feed water tank. This enabled a simplified system in which water could be fed into the reactor using gravity by positioning the water tank above the reactor, eliminating any need for CO₂ pressuring. Because the reactor operates at a higher pressure than the cooling jacket, the boiling point of water in the reactor is elevated, allowing water to boil at a lower temperature in the jacket and to cool and condense water vapor in the reactor. This eliminates the need for an outside radiator.

Generally, the tank is not filled with water until it is time to takeoff for the mission and the safety valve is not opened until immediately before the parachute drops. The control valve, which opens after parachute deployment, could be set in advance (e.g., by an airman) to allow a given amount of water to flow before it closes. This makes the system adaptable for use with payloads of different sizes.

In a test, hydrogen gas was generated at a rate of about 100 lpm. About 150 lpm of steam was also generated, but the air launch PBLS' built in condenser system allows this to be condensed in the reactor, so that only the hydrogen was delivered to the balloon.

### PBLS Applications

The PBLS directly meets existing Air Force needs to replace helium with a more widely available alternative for use in balloon inflation. Supplies of helium are limited, and costs are high, running typically about $40 per kilogram of lift if the launch is being done in the continental United States, much more overseas, and vastly more if the launch needs to be done in a remote theater of military operations. Furthermore, helium is a finite resource and may become unavailable in the future.

Lift gas is necessary to enable the launch of radiosondes, which is typically done twice a day at both military and civilian airports to obtain data about winds aloft to support aviation operations. Radiosondes are also used by artillery units and space launch operations for the same purpose. The PBLS a portable unit that can readily be taken into remote areas by ground teams, and used to launch balloons from ships, as well as established airfields both in the US and abroad.

The PBLS works by reacting water with a strong reducing agent to produce pure hydrogen gas. These reactions are exothermic, and so require no power source to be driven. As a result, elegantly designed systems are possible, enabling rapid inflation of balloons not only on the ground, but during parachute drop.

The PBLS produces lift gas at a cost of about $30/kg of lift. This is the same as helium within the continental US, but much cheaper than helium overseas. Its principal advantage is system simplicity, making it ideal for air launch, sea launch, and ground operations from remote locations.

While we have focused our attention on small PBLS units meeting the need of launch of radiosondes, lightweight communication relays, ISR payloads, and small gliders, the PBLS can readily be scaled to any size necessary, up to an including that needed to support the flight of large aerostats carrying radars or other systems.

### Use of PBLS to Launch Gliders for Precision Reconnaissance

It is possible to predict the flight path of a balloon launched from the ground based on known winds and the ascent rate. The ascent rate of the latex balloons that are optimal for military field applications is typically constant, with about 1000 ft/min being the preferred rate for radiosondes. However much greater horizontal flight distances can be achieved by inflating the balloon with less gas, thereby achieving a slower ascent rate.

Alternatively, two balloons can be used, for example a 600-gm balloon and a 350-gm balloon, with each filled with just enough gas to lift the payload by itself, plus a relatively small amount of free lift. In such an application, the system will have over 100% free lift at launch, and thus ascend quickly until the burst altitude of the smaller balloon is reached, which may be about 20,000 ft below the burst altitude of the larger balloon. In this case, after the burst of the smaller balloon, at perhaps 80,000 ft, the system will have greatly reduced ascent velocity, and take hours before the 100,000 ft burst altitude of the larger balloon is reached. During this time, it could travel hundreds of kilometers. And, using this technique, a balloon can be aimed at getting close to a target of interest deep into enemy territory. For many applications, this is good enough. However, for some applications precision targeting of the balloon instrument is necessary. This can be accomplished by having the instrument be carried by a glider, which is carried by the balloon.

In one test, balloons were launched from Lakewood Colo. carrying a GPS-directed glider developed by Commit Technologies. Using the 4 kg of lift gas PBLS embodiment, which produces hydrogen gas by reacting water with NaBH₄, 3.2 kg worth of lift gas was generated to inflate a 600-gm balloon carrying Commit's 1.2 kg glider and a 400-gm cutaway system to 65,000 ft. The cutter then released Commit's glider which took a preprogrammed course to a targeted destination.

The glider targeted and reached Hudson Colo. The glider was then recovered, and on the next day it targeted and reached Kiowa Colo. Both targets were approximately 100 km from the launch point in Lakewood Colo.

Carried by balloons conveniently launched from ground, sea, or air, small drones could be used to reach almost anywhere.

Even greater ranges can be achieved by using the PBLS to launch a hydrogen balloon and use that to lift a solar balloon to high altitude and then drop it. The solar balloon is a black zero pressure balloon than inflates like a parachute with ram pressure when it is dropped. As a result of its black coloration, it is heated up by sunlight. It then can assume level flight until sundown.

In another test, the 4 kg of lift gas PBLS embodiment was used to inflate a 350 gm rubber balloon with hydrogen, using it as a carrier to lift a 200 gm cutter system. A 350 gm uninflated black solar balloon plus 200 gms of tracking payloads were suspended with the PBLS.

In relatively cold overcast weather with light snow, the carrier took the system to 65,000 feet at 1:23 PM (MT) where the cutter activated, dropping the black solar balloon and its trackers. The black solar balloon inflated like a parachute, heating as it descended ever more slowly to achieve stable level flight at 44,000 ft. The PBLS then continued to fly level at that altitude in a direct line towards Wichita Kansas at speeds exceeding 160 kilometers per hour. Surrounding air temperatures were −10° C.

The PBLS traveled past Great Bend, Kans., about 130 km northwest of Wichita, having travelled 580 km since launch. The balloon had begun to descend reaching 34,000 ft, but still traveling east southeast at 198 kilometers per hour. Air temperature was −37 C.

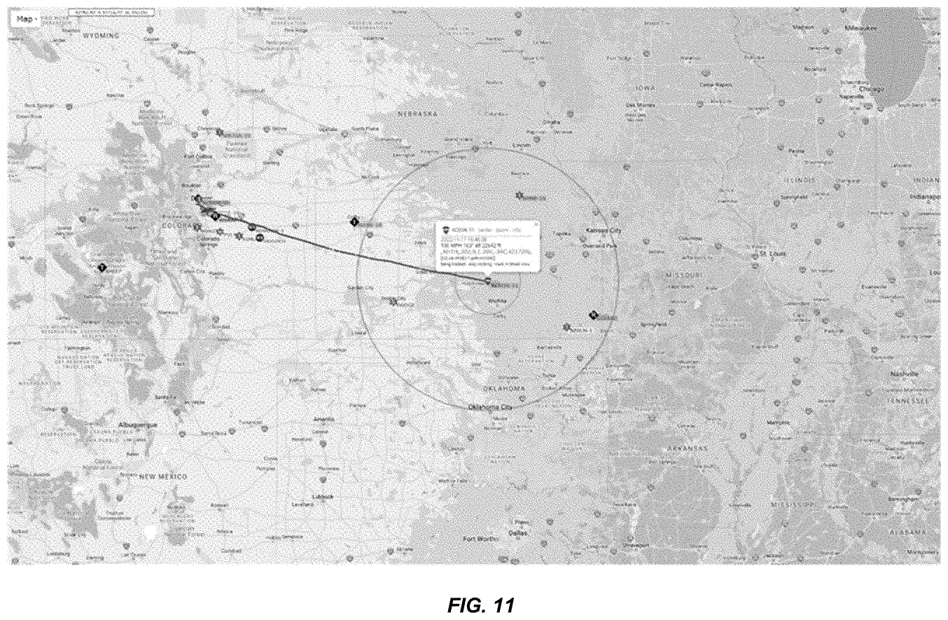

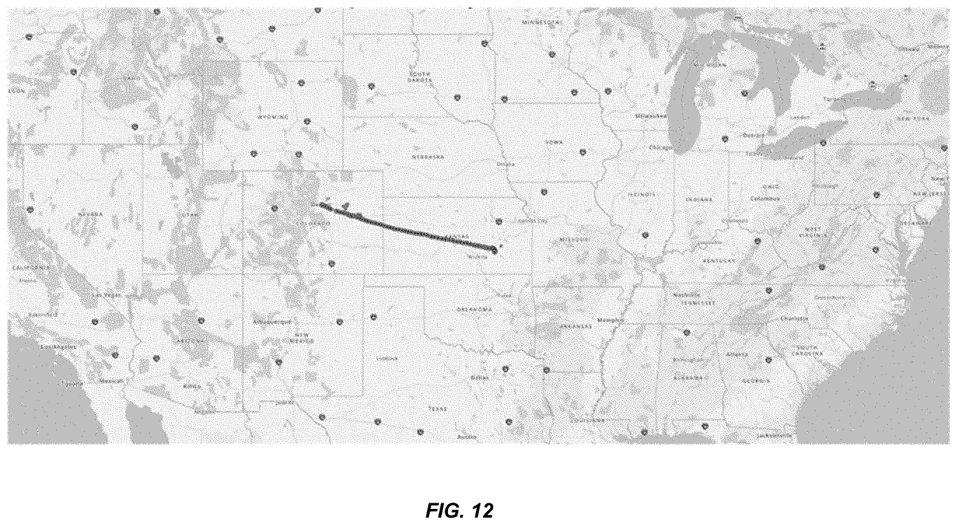

As it descended to lower altitudes, the wind speed dropped, so most of the progress was made during daylight and 1 hour afterwards. The flight concluded about two hours after sunset in Kansas, with the balloon having travelled approximately 800 km. FIG. 11 illustrates the ground track of the PBLS, and FIG. 12 shows the complete flight of the PBLS.

Employed in this way, the PBLS can be used to launch solar balloons before dawn or during unfavorable overcast weather which would otherwise prevent a solar balloon launch. The solar balloon can then be used to carry gliders or other payloads useful for reconnaissance and/or other purposes requiring precision delivery over very long ranges.

What is claimed is:

1. A balloon launch system, comprising:
a tank operable to retain water;
a reactor fluidly coupled to the tank and comprising a reductant material that reacts with the water to produce a lift gas;
a first valve operable to release the water into the reactor; and
an exhaust operable to vent the lift gas into a balloon to inflate the balloon, the lift gas being lighter than air to lift the balloon into an atmosphere.

2. The system of claim 1, further comprising:
condenser vessels designed to condense any steam that is produced by an exothermic reaction between the reductant material and the water.

3. The system of claim 2, wherein:
the water derived from the condensed steam is fed back to the reactor.

4. The system of claim 1, further comprising:
a parachute operable to deploy when the system is jettisoned in the atmosphere.

5. The system of claim 4, further comprising:
a release mechanism operable to detach the parachute from the balloon when the balloon is lifted into the atmosphere.

6. The system of claim 1, further comprising:
a release mechanism operable to detach the tank and the reactor from the balloon when the balloon is lifted into the atmosphere.

7. The system of claim 1, wherein:
the reductant material is NaBH₄, LiH, Na₂Si₂, B₄C, MgH₂, TiH₂, NaBH₄, LiBH₄, LaAlH₄, NaAlH₄, Al, Si, FeSi₂, CaSi₂, or CaH₂.

8. The system of claim 1, wherein:
the reductant material is NaBH₄; and
the NaBH₄ is mixed with H₃BO₃.

9. The system of claim 8, wherein:
a ratio of H₃BO₃ to NaBH₄ used is greater than 1:1 by weight.

10. The system of claim 1, further comprising:
a cooling loop operable to cool the lift gas before the lift gas enters the balloon.

11. The system of claim 1, further comprising:
a second valve operable to release the lift gas from the balloon, and
a controller operable to control an ascent of the balloon by controlling the second valve to govern the amount of lift gas being released from the balloon

12. The system of claim 1, wherein:
the balloon is used to lift gliders to high altitude and then drop the gliders for guiding to designated target objectives.

13. The system of claim 12, wherein:
the gliders are used for long range reconnaissance missions or other missions requiring precision delivery of payloads.

14. The system of claim 1, wherein:
the balloon is used to lift a solar balloon to high altitude and then to drop the solar balloon to achieve inflation regardless of weather or light conditions.

15. A method of launching a balloon, comprising:
fluidly coupling a reactor to a source of water, wherein the reactor holds a material that reacts with the water;
opening a first valve to release the water into the reactor to produce a lift gas based on a reaction between the water and the reductant material; and
exhausting the lift gas from the reactor into the balloon to inflate the balloon, the lift gas being lighter than air to lift the balloon into an atmosphere.

16. The method of claim 15, further comprising:
deploying a parachute when the reactor and balloon are jettisoned into the atmosphere from an aircraft or a space capsule, enabling balloon inflation during parachute descent.

17. The method of claim 16, further comprising:
detaching the parachute from the balloon when the balloon is lifted into the atmosphere.

18. The method of claim 15, wherein:
the reductant material is NaBH₄, LiH, Na₂Si₂, B₄C, MgH₂, TiH₂, NaBH₄, LiBH₄, LaAlH₄, NaAlH₄, Al, Si, FeSi₂, CaSi₂, or CaH₂.

19. The method of claim 15, wherein:
the reductant material is NaBH₄; and
the NaBH₄ is mixed with H₃BO₃.

20. The method of claim 19 wherein:
a ratio of H₃BO₃ to NaBH₄ used is greater than 1:1 by weight.

21. The method of claim 15, further comprising:
condensing steam produced by the reaction into water;
removing the water from the lift gas; and
returning the water to the reactor

22. The method of claim 15, further comprising:
releasing the lift gas from the balloon, via a second valve; and
electronically controlling an ascent of the balloon by controlling the second valve to govern an amount of lift gas being released by the balloon.

23. The method of claim 15, further comprising:
using the balloon to lift gliders to high altitude and then to drop the gliders for guiding to designated target objectives.

24. The method of claim 15, further comprising:
using the balloon to lift a solar balloon to high altitude and then drop the solar balloon to achieve inflation regardless of weather or light conditions.
